(19) United States
(12) Patent Application Publication
(10) Pub. No.: US 2015/0328069 A1
(43) Pub. Date: Nov. 19, 2015

(54) SHOWER CHAIR/WALKER COMBINATION

(71) Applicant: GARY M. STAGGS, COLLEYVILLE, TX (US)

(72) Inventor: GARY M. STAGGS, COLLEYVILLE, TX (US)

(21) Appl. No.: 14/715,516

(22) Filed: May 18, 2015

Related U.S. Application Data
(60) Provisional application No. 61/994,819, filed on May 16, 2014.

(51) Int. Cl. A61G 7/00; A61G 5/10; A61H 3/04; A47K 3/28; A47K 13/00

(52) U.S. Cl. CPC A61G 7/0005; A47K 3/282; A47K 13/005; A61H 3/04; A61G 5/1002; A61H 2003/046; A61H 2201/0115; A61H 2201/0161; A61H 2201/1633

(57) ABSTRACT

The shower chair/walker combination incorporates the features of a walker, a shower chair, a toilet seat, a transport chair and a general support seat. The combination includes a folding walker having a removable seat and lid pivotally mounted thereon. The seat is of a low profile, full toilet seat design. A pivotally mounted backrest allows the appliance to be easily converted for use in the above-mentioned forms. The appliance is provided with brakes and controls therefor.

### CROSS-REFERENCE TO RELATED APPLICATION

This application claims the benefit of U.S. Provisional Patent Application Ser. No. 61/994,819, filed May 16, 2014.

### BACKGROUND OF THE INVENTION

1. Field of the Invention

The present invention generally relates to appliances for the elderly or handicapped, and particularly to a shower chair/walker combination that is usable as a walker, shower chair, toilet seat, transport chair, and general support seat for the injured and/or disabled.

2. Description of the Related Art

In hospitals, nursing facilities, and even in the private home, it is often necessary for a disabled and/or elderly patient to have a shower for adequate cleansing. Often, this endeavor requires the use of two appliances. One appliance (a walker or wheelchair) is needed to transport the patient to the shower area. A second appliance is needed to provide support while the patient is actually taking the shower. The use of walkers or wheelchairs for providing mobility for disabled people is a well-known concept in the related medical arts. So too is the use of shower chairs for people who find it difficult to stand while taking a shower. Because of their weakened condition, disabled, elderly and injured people also find it difficult to use unmodified or standard toilet facilities. Additionally, it is often difficult to seat disabled and elderly people at dining facilities in restaurants or in the home. A variety of walkers, wheelchairs and shower chairs are disclosed in the related arts and are commercially available. It would certainly be advantageous if these appliances could be combined into a single appliance for enhancing the mobility of the disabled, elderly or injured to accomplish the various tasks described above. Thus, a shower chair/walker combination solving the aforementioned problems is desired.

### SUMMARY OF THE INVENTION

The present shower chair/walker combination is an improvement of the device described in Applicant's U.S. Pat. No. 8,480,100, issued on Jul. 9, 2013, and incorporates the features of a walker, a shower chair, a toilet seat, a transport chair and a general support seat. The combination comprises a folding walker having a removable seat and lid pivotally mounted thereon. The seat is of a low profile, full toilet seat design. The low profile feature allows a caregiver to have access to all parts of the patient's body to assure complete bathing. A pivotal backrest allows the appliance to be easily converted for use into the above-mentioned forms. The appliance is provided with brakes and controls therefor. All joints and moving parts are fabricated from rust-resistant materials.

Accordingly, the invention presents a medical appliance that can be converted to accomplish various tasks. The appliance is fabricated from high-strength materials and provided with wheels for easy movement. The appliance is also foldable to enhance storage capability. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is a perspective view of a shower chair/walker combination according to the present invention as seen from the bottom thereof.

FIG. 2 is a perspective view of the shower chair/walker combination of FIG. 1 as seen from the top.

FIG. 3 is an environmental side view of the shower chair/walker combination of FIG. 1, showing the position of the backrest when the appliance is used as a transport chair.

FIG. 4 is an environmental, side view of the shower chair/walker combination of FIG. 1, showing the position of the backrest when the appliance is used as a shower or toilet chair.

FIG. 5 is a side view of the shower chair/walker combination of FIG. 1, showing the backrest in a raised, vertical position.

Similar reference characters denote corresponding features consistently throughout the attached drawings.

### DETAILED DESCRIPTION OF THE PREFERRED EMBODIMENTS

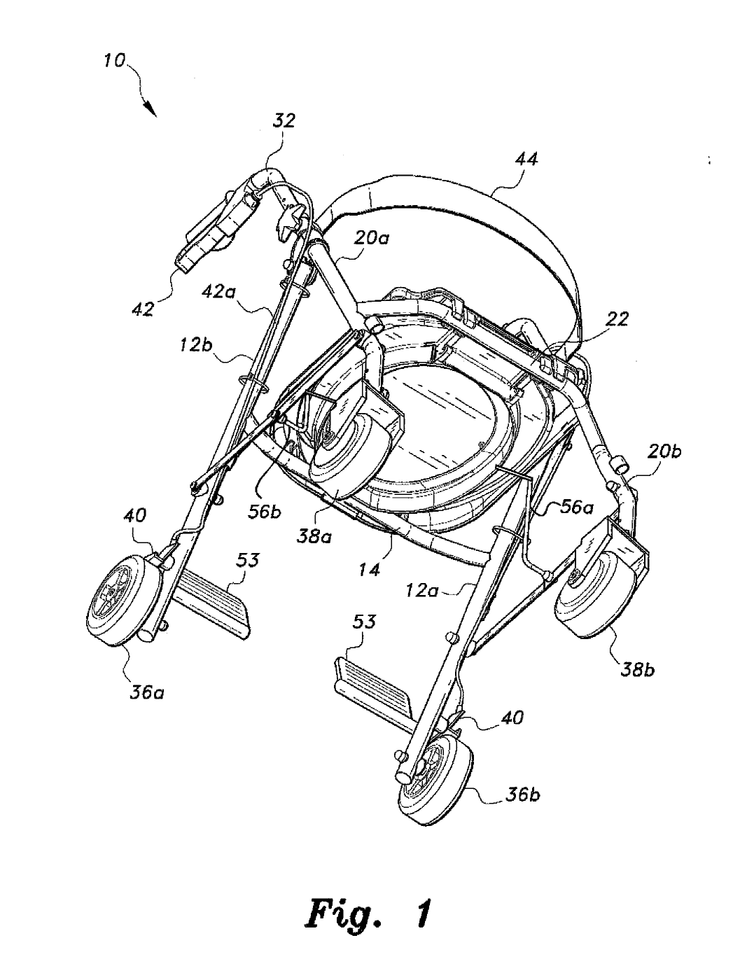

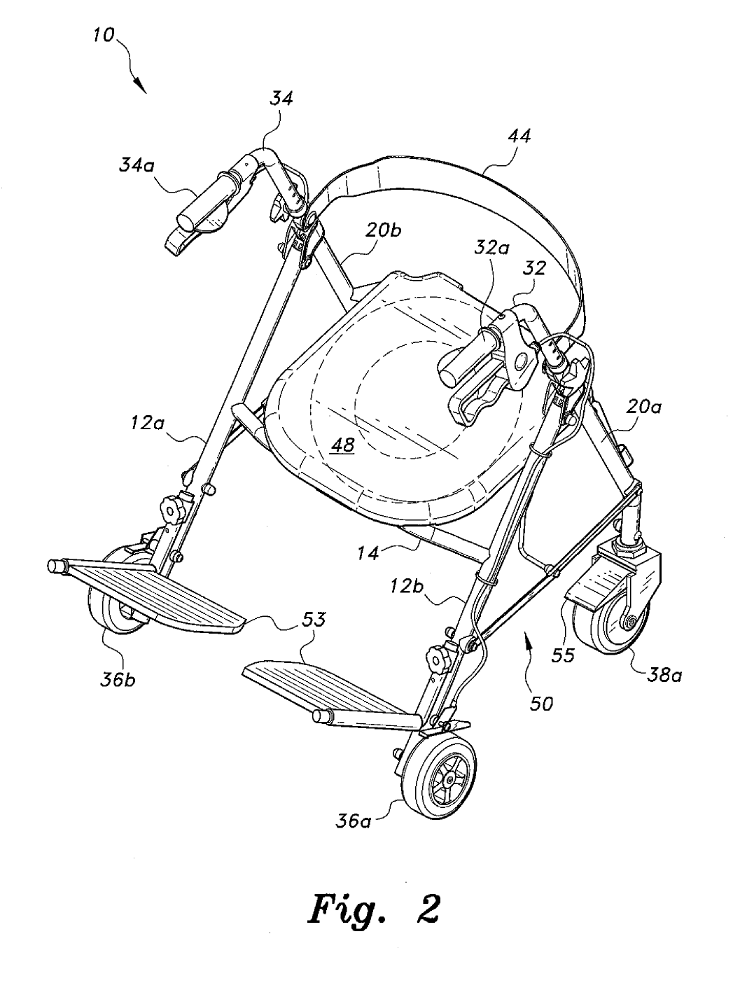

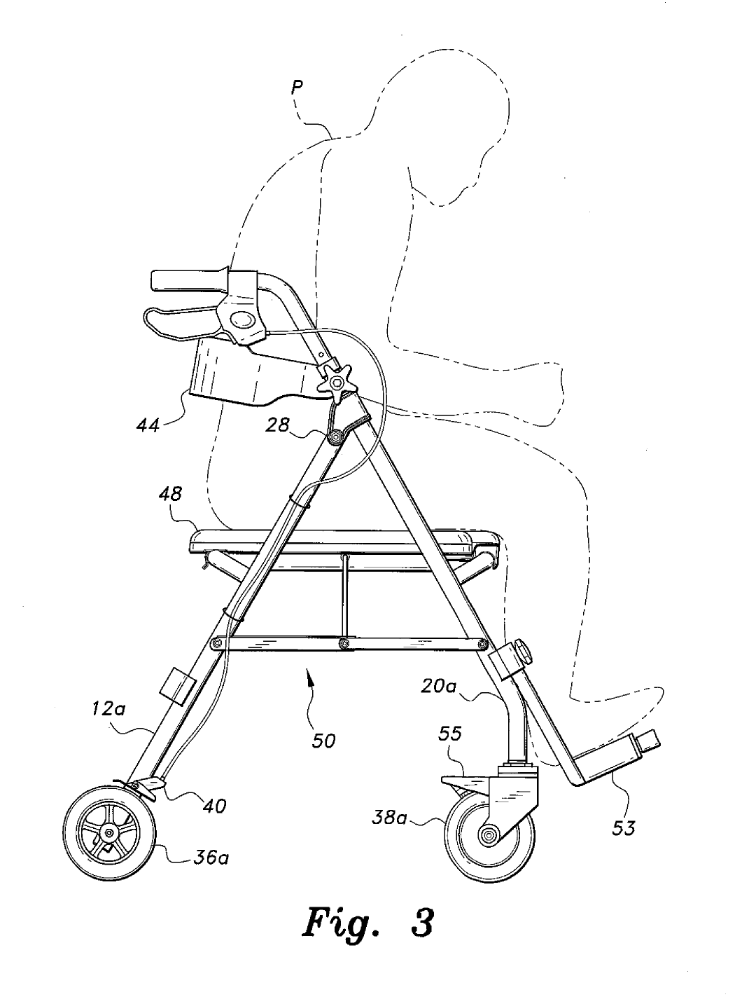

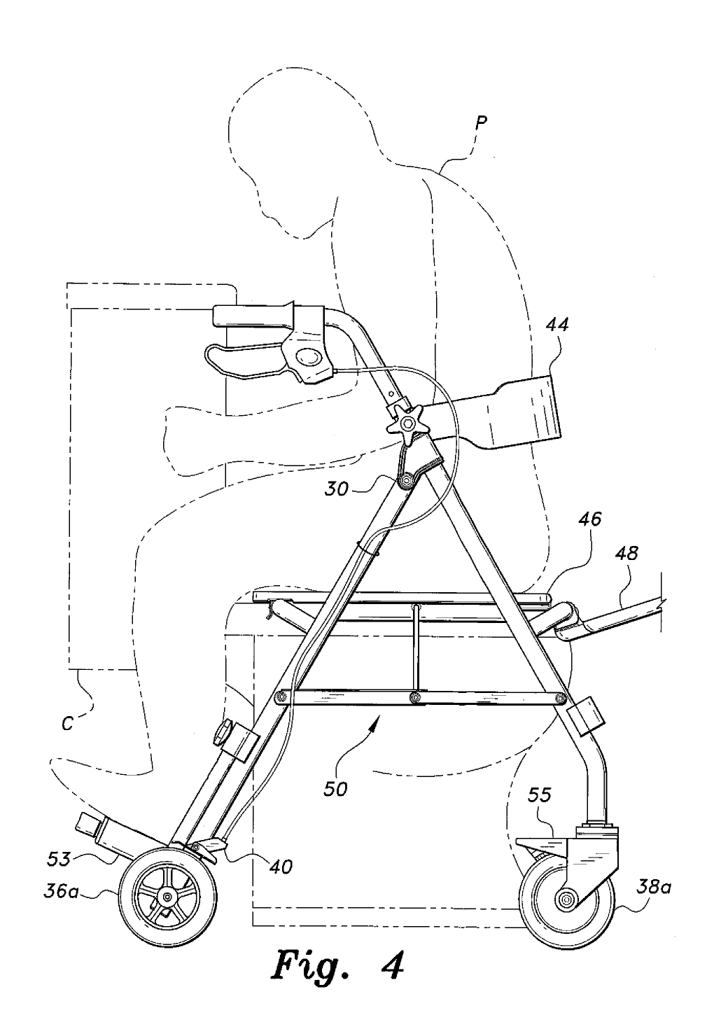

With reference to FIGS. 1-5, the shower chair/walker combination is generally indicated at 10. The combination 10 comprises a rear frame having a pair of spaced, tubular rear leg members 12a and 12b, each leg member 12a, 12b having an upper and a lower end. A tubular cross-brace member 14 spans the space between the rear leg members 12a, 12b and is attached thereto, preferably by welds. A front frame member comprises a pair of spaced, tubular front leg members 20a and 20b. The front leg members 20a, 20b are spaced forward of rear leg members 12a, 12b. Each front leg member 20a, 20b has an upper end and a lower end. A tubular cross-brace member 22 spans the space between the front leg members 20a, 20b and is attached thereto, preferably by welds. The front leg members 20a, 20b are pivotally attached to the rear leg members 12a, 12b at respective pivot connections 28 (FIG. 3), 30 (FIG. 4). First and second handle members 32 and 34 are disposed in the respective front leg members 20a, 20b and are telescopically adjustable therein to accommodate patients of different heights. Each handle member 32, 34 is provided with a respective hand grip 32a, 34a thereon. The respective lower ends of rear leg members 12a, 12b are provided with wheels 36a, 36b, which are secured to axles rigidly extending from each respective lower end of the rear leg members 12a, 12b. The respective lower ends of front leg members 20a, 20b are also provided with wheels 38a. 38b, which are caster wheels attached for swiveling movement. Braking elements 40 are positioned adjacent rear wheels 36a, 36b. Brake controls 42 are mounted on the handle members 32, 34 and function to operate the braking elements 40 via control lines 42a. Foot brakes 55 are provided for front wheels 38a, 38b for optimum safety.

A backrest member 44 has respective ends mounted to the front leg members 20a, 20b. The backrest member 44 is mounted for 180° pivotal movement. This arrangement permits the combination 10 to be utilized for a variety of tasks without removing and repositioning the backrest member from the front leg members to the rear leg members. For example, if the backrest 44 is pivoted in the position shown in FIG. 3, the combination 10 can be used as a transport chair. As shown in FIG. 4, the backrest 44 is in a position wherein the chair functions as a toilet or shower chair. It should be noted that the backrest member could be pivotally mounted to leg members 12a, 12b if desired. A respective pivoting, vertically adjustable, removable footrest assembly 53 is mounted to each leg member 12a, 12b. The footrests may be mounted to legs 20a, 20b, if necessary. The footrests 53 enhance the comfort of the patient.

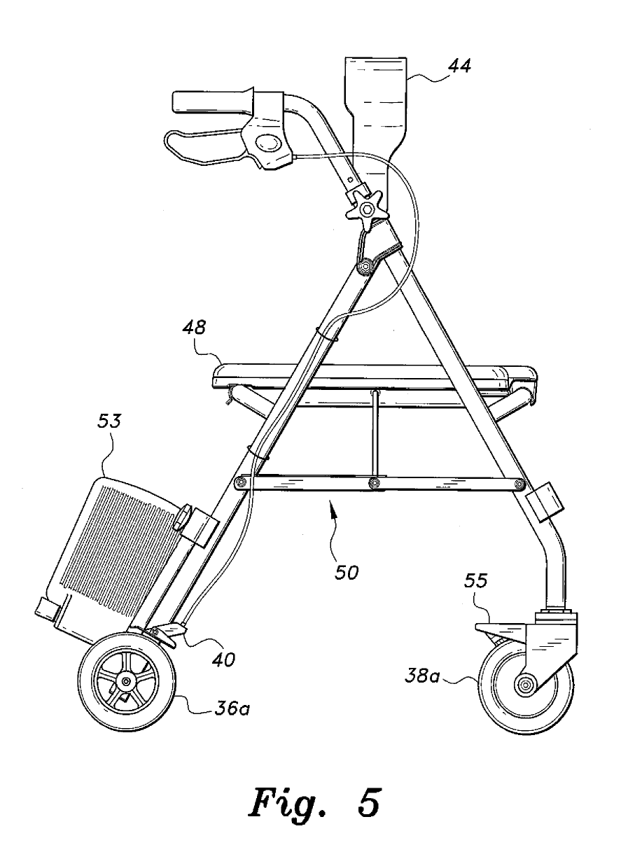

A toilet seat 46 and lid 48 are mounted to tubular member 22 for pivotal movement thereon. Both the seat 46 and lid 48 are designed to be easily removable from member 22, if desired. The toilet seat 46 and lid 48 are of a low profile, full-size configuration, as is conventional in the art. Rotation of the backrest 44 to a position (vertically upright) shown in FIG. 5 allows the lid 48 to be easily rotated and/or removed to provide full access to the patient's body for thorough cleansing when showering or the like. Folding bar support members 50 and 52 are attached to the front and rear frame members to provide stability. Bar support members 50 and 52 are hinged at their respective centers to permit folding. Respective rods 56a, 56b extend from support members 50, 52 to toilet seat 46 to facilitate folding the device 10.

In use, a patient P (shown in phantom lines) can employ the appliance as a walker, toilet chair, shower chair, transport chair or seat. The overall width of the appliance is designed to allow easy clearance of conventional 24-inch bathroom doorframes. Tubular members 14 and 22 are positioned at a height to permit the combination 10 to clear the top of a standard commode C (conventional for handicapped users). The lid 48 provides for an aesthetically pleasing arrangement when the combination 10 is employed in public as a walker, dining chair or the like. The footrest assemblies may be positioned and adjusted to provide maximum comfort for the patient.

It is to be understood that the present invention is not limited to the embodiment(s) described above, but encompasses any and all embodiments within the scope of the following claims.

I claim:

1. A shower chair/walker combination, comprising:
a front frame member having lower ends;
a rear frame member pivotally attached to the front frame member, the rear frame member having lower ends;
a first pair of wheels mounted on the lower ends of the front frame member;
a second pair of wheels mounted on the lower ends of the rear frame member;
a pair of folding bar support members connecting the front frame member to the rear frame member;
a front cross-brace member attached to the front frame member;
a rear cross-brace member attached to the rear frame member;
a seat pivotally mounted on the front cross-brace member;
a lid pivotally mounted on the front frame member, the lid overlying the seat for optionally covering the seat;
a removable footrest assembly mounted on the front frame member and a backrest pivotally mounted on the front frame member.

2. The shower chair/walker combination according to claim 1, wherein said backrest is pivotal through an angle of 180 degrees.

3. The shower chair/walker combination according to claim 1, wherein the combination is fabricated from lightweight, rust-resistant materials.

4. The shower chair/walker combination according to claim 1, further comprising braking elements disposed adjacent said first pair of wheels and said second pair of wheels.

5. A shower chair/walker combination, comprising:
a front frame member having lower ends;
a rear frame member pivotally attached to the front frame member, the rear frame member having lower ends;
a first pair of wheels mounted on the lower ends of the front frame member;
first braking elements disposed adjacent the first pair of wheels a second pair of wheels mounted on the lower ends of the rear frame member second braking elements disposed adjacent the second pair of wheels;
a pair of folding bar support members connecting the front frame member to the rear frame member;
a front cross-brace member welded to the front frame member;
a rear cross-brace member welded to the rear frame member;
a seat pivotally mounted on the front cross-brace member;
a lid pivotally mounted on the front frame member, the lid overlying the seat for optionally covering the seat;
a removable footrest assembly mounted on the front frame member and
a backrest pivotally mounted on the front frame member, the backrest being pivotal through an angle of 180 degrees.

6. The shower chair/walker combination according to claim 5, wherein said first braking elements are foot-operated braking elements and said second braking elements are hand-operated braking elements.

7. The shower chair/walker combination according to claim 6, wherein said foot rest assembly is vertically adjustable.
